(19) United States
(12) Patent Application Publication
(10) Pub. No.: US 2012/0305032 A1
(43) Pub. Date: Dec. 6, 2012

(54) METHOD AND APPARATUS FOR DISLODGING INSECTS FROM PLANTS

(76) Inventor: Patrick J. O'Donnell, San Juan Capistrano, CA (US)

(21) Appl. No.: 13/402,578

(22) Filed: Feb. 22, 2012

Related U.S. Application Data
(63) Continuation of application No. 09/557,234, filed on Apr. 24, 2000, now abandoned.

(51) Int. Cl. B08B 3/02

(52) U.S. Cl. 134/34; 134/198

(57) ABSTRACT

A spraying apparatus for simultaneously dislodging insects from a plant's leaves and cleaning the plant includes a tubular handle portion having a bend point and being connected to a substantially straight tubular main body portion. A nozzle portion at a distal end of the main body is adapted to create a substantially planar wall of water around the nozzle portion when the apparatus is connected to a source of water under pressure. In operation, a user holds the handle so that the main body is substantially horizontal and advances the nozzle into and out of the plant at a plurality of locations. The wall of water is directed in all directions and dislodges insects from the top and bottom sides of infested leaves. Additionally, the wall of water dislodges dirt and insect waste and directs it downwardly off of the plant with the flowing wall of water. The bent handle enables the user to treat the plant at varying locations without excessive bending and craning.

### CROSS-REFERENCE TO RELATED APPLICATIONS

This application is a continuation of U.S. patent application Ser. No. 09/557,234, which was filed on Apr. 24, 2000, the entirety of which is hereby incorporated by reference.

### BACKGROUND OF THE INVENTION

1. Field of the Invention

This invention relates to a method and apparatus for cleaning plants and dislodging insects therefrom. More specifically, the invention relates to a sprayer and a method of using the sprayer to blast insects off of plant leaves.

2. Description of the Related Art

Insect pests present ongoing challenges for professional and amateur gardeners. Such undesirable insects can damage a plant's health and aesthetic appeal. For example, whiteflies generally feed on the undersides of plant leaves using piercing-sucking mouth parts to puncture the leaf cells and suck plant juices. The tops of the leaves become pale, yellow and eventually will drop. Whiteflies also produce a sticky honeydew-like residue which can be a substrate for a black sooty mold. The sooty mold is not only unattractive, but also interferes with photosynthesis, leading to reduced plant vigor. The honeydew also attracts ants, which may make the garden area less appealing. Other garden pests such as aphids, spider mites, caterpillars and mealy bugs also damage plant health and aesthetics.

Several methods and devices have been used in an attempt to control insects such as whiteflies. In one method, beneficial insects that prey on whiteflies are released into the garden. This method has the advantage of using a natural means to control the undesired insects. However, the predator insects tend to disburse quickly and generally do not reproduce at the same pace as the undesirable insects. This can result in high costs to continuously replenish or maintain a sufficient population of beneficial predator insects.

Insecticides are also used in an attempt to effectively control insects. However, certain insects, such as whiteflies, can be resistant to many types of insecticides, thus limiting the effectiveness of these insecticides. Additionally, since the life cycle of whiteflies can be as little as about six (6) weeks, treatment with insecticides must be repetitive and continuous to be effective. This results in considerable expense. Further, insecticides can be toxic to humans, pets, beneficial insects, and the environment. The limited effectiveness of insecticides is generally not worth the significant expense and toxicity resulting from their use.

Spraying plants with a soap solution has also been suggested as an effective means for dislodging insects such as whiteflies. Soap spray is certainly less toxic than other insecticides, but still raises environmental concerns and provides only limited effectiveness.

In another approach, yellow sticky traps are placed around an infested plant. The insects are attracted to the yellow sticky traps and become stuck therein. These traps, however, are unsightly and generally do not trap non-flying insects, such as immature whiteflies. Accordingly, traps alone may not provide sufficient control.

A yet further approach, known as vacuum sweeping, involves placing a vacuum nozzle close to the plant and then shaking the plant. Whiteflies attempting to fly away from the shaken plant are sucked up by the vacuum. As with yellow sticky traps, vacuum sweeping has limited effectiveness and generally cannot effectively control a whitefly population. It can also require considerable expense and access to sophisticated vacuum equipment.

It has also been suggested to spray a plant with a stream of water in order to dislodge insects from the plant. Specialized devices exist for blasting the undersides of plant leaves to dislodge insect pests, particularly spider mites.

One such leaf-blasting device is the “Water Wand for Spider Mites,” which is manufactured by Walter H. Vinton. This device has a tube which attaches to a garden hose and has a cone-type nozzle directed upwardly. Another device is the “Jet-All Water Wand,” which is available from Kimbrew-Walter Roses. This device also comprises a tube that is connectable to a garden hose. Three fan-type plastic nozzles direct spray upwardly from the end of a curved PVC pipe.

Both of the above devices are intended for use spraying the undersides of plant leaves in order to remove pests such as spider mites. These devices, however, are cumbersome and time-consuming to use. For example, various regions of a plant, particularly the high and low regions of the plant, are inconvenient to treat with either of these devices. For example, to treat areas of the plant close to the ground, it may be necessary for the user to get down on his hands and knees in order to direct the spray at the underside of leaves near the bottom of the plant. In high areas of the plant, it can be difficult to maintain the spray in an upwardly directed fashion. Instead, portions of the spray are directed back at the user. Additionally, it may be difficult to negotiate the tube through the plant in relatively high regions of the plant, making it difficult to access leaves within the plant's higher regions.

These existing devices are especially time-consuming and inefficient for treating many-leafed, relatively large plants, such as hedges, because the user must aim the spray at each leaf that is to be treated. A further disadvantage is that these devices require additional effort to clean substances such as sooty mold and honeydew, which may result from an infestation. A still further disadvantage is that insects on the tops of the leaves may escape treatment and insects blasted off the underside of one leaf may drop down to a top side of a leaf immediately below the treated leaf, and thus remain on the plant.

### SUMMARY OF THE INVENTION

Accordingly, there is a need in the art for an improved device and method for dislodging insects from and simultaneously cleaning plant leaves. There is a further need in the art for such a device that can be conveniently used at various elevations, is easy to control, and can quickly treat plants having a high number of leaves, effectively treating both the top and bottom sides of plant leaves.

In accordance with one aspect of the present invention, a hand-held spray apparatus for removing insects from and cleaning plant leaves is provided. The apparatus comprises a substantially rigid tubular handle portion adapted to be connected to a source of pressurized water. The handle portion has a substantially straight proximal section, a substantially straight distal section, and a bend point between the proximal and distal sections. A nozzle portion is provided at a generally distal end of the end portion. The nozzle portion is adapted to direct a flow of the pressurized water to create a substantially planar wall of water directed outwardly about the circumference of the nozzle. The wall of water is substantially perpendicular to a longitudinal axis of the nozzle portion. A rotation axis is defined parallel to the handle distal section and through a point adjacent a proximal end of the handle portion. Rotating the apparatus about the rotation axis when the handle distal section is in a generally horizontally attitude changes the elevation of the distal section without changing its attitude.

In accordance with another aspect, the present invention provides a hand-held spray apparatus for removing insects from and cleaning plant leaves. The apparatus comprises a substantially rigid handle portion, an elongate substantially rigid body portion communicating with the handle portion, and a nozzle portion at a generally distal end of the body portion. The nozzle portion is adapted to be connected to a source of pressurized water and directs the pressurized water in an outwardly directed flow around at least half of the circumference of the nozzle portion.

In accordance with a further feature of the above aspect, the nozzle portion comprises a tube and an end plug. The end plug has a plug body and a dispersing plate. At least a portion of the plug body lies within the tube, and a space is defined between the dispersing plate and a distal end of the tube so that water flowing through the nozzle portion flows between the tube and the plug body and through the space.

In accordance with a still further aspect of the present invention, a method is provided for removing insects from and cleaning a plant having leaves. The method comprises providing a hand-held spraying apparatus having a handle, an elongate body portion, and a nozzle portion at a generally distal end of the body portion. The nozzle portion is adapted to direct water flow outwardly therefrom around the circumference of the nozzle portion. A source of water under pressure is placed into communication with the spraying apparatus. The nozzle is positioned adjacent an underside of a plant leaf so that a portion of the water directed by the nozzle impacts the leaf underside, and the apparatus is advanced and retracted so that a flow of water impacts the leaf underside along its length.

In accordance with another feature of the above aspect, the nozzle portion directs water flow in at least one substantially vertical plane and the elongate body portion is held in a substantially horizontal attitude.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a perspective view of a spraying apparatus having features in accordance with the present invention.

FIG. 2 shows a distal portion of the spraying apparatus of FIG. 1 being used among plant leaves.

FIG. 3A shows a side view of a first embodiment of a nozzle for use with the present invention.

FIG. 3B shows an insert plug for use in the nozzle of FIG. 3A.

FIG. 3C shows a proximal end view of the insert plug of FIG. 3B.

FIG. 3D shows a distal end view of the nozzle of FIG. 3A.

FIG. 4A shows a side view of another embodiment of a nozzle for use with the present invention.

FIG. 4B shows a side view of an end plug for use with the nozzle of FIG. 4A.

FIG. 4C shows a proximal end view of the plug of FIG. 4B.

FIG. 5 shows a cross-sectional side view of yet another embodiment of a nozzle for use with the present invention.

FIG. 6A shows a cutaway side view of a still further embodiment of a nozzle for use with the present invention.

FIG. 6B shows a proximal end view of an intermediate plug for use with the nozzle of FIG. 6A.

FIG. 7A shows a side view of a tubular main body for use in accordance with the present invention.

FIG. 7B shows a side view of a bent tubular handle for use in accordance with the present invention.

FIG. 8A shows a spraying apparatus having features in accordance with the present invention shown at three locations relative to a plant.

FIG. 8B shows an end view of the apparatus of FIG. 8A at the three elevations.

FIG. 9A is a perspective view of another embodiment of a nozzle having features in accordance with the present invention.

FIG. 9B is an en end view of the nozzle of FIG. 9A, showing general water flow directions as directed by the nozzle.

### DETAILED DESCRIPTION OF THE PREFERRED EMBODIMENT

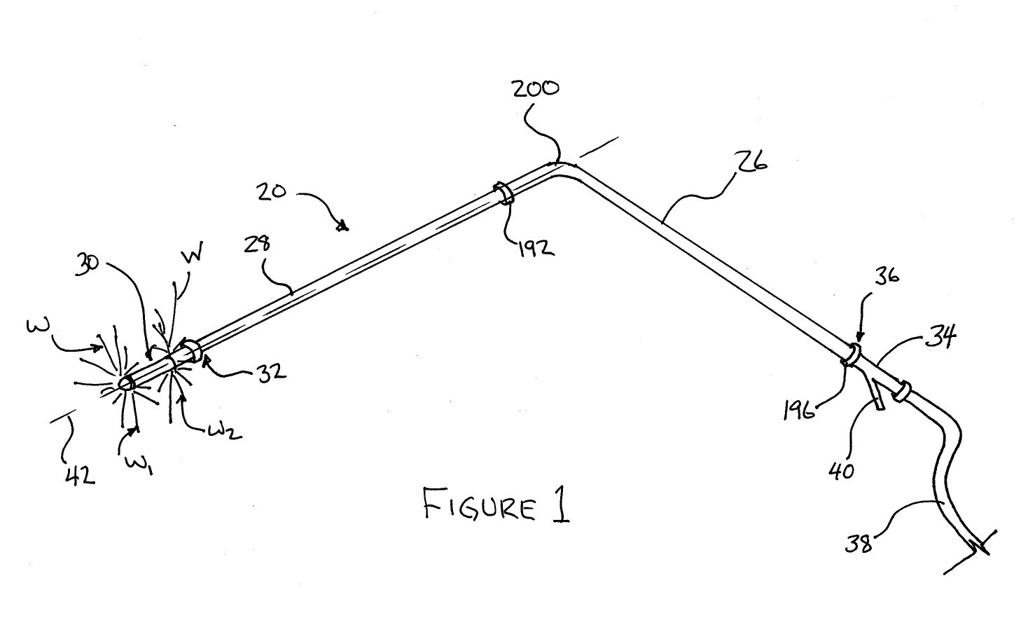

With reference first to FIG. 1, an apparatus 20 is shown for directing a pair of spaced-apart, substantially planar walls of water W₁, W₂ at plant leaves to dislodge insects such as whiteflies from the leaves and to clean the plant. The embodiment represented by apparatus 20 preferably comprises a bent tubular handle 26 attached to a substantially straight tubular main body 28. A nozzle portion 30 is attached to a distal end 32 of the main body 28. The handle 26 and body 28 are adapted to conduct water under pressure therethrough. A controller 34 is preferably connected to a proximal control end 36 of the handle. The controller 34 preferably connects to a garden hose 38 and includes a valve that can be opened and closed to control the flow of water through the apparatus 20. The controller 34 shown is actuated by a trigger 40, but any appropriate controller or valve actuator may be used. Although the present invention is shown connected to a conventional garden hose 38, any source of pressurized water, such as a pressurized tank or the like, may appropriately be used.

As shown in FIG. 1, the nozzle portion 30 is adapted to create two spaced-apart walls of water W₁, W₂. In alternative embodiments, the nozzle 30 can be adapted to create only one wall of water, or three or more walls as desired. In the embodiment of FIG. 1, each wall of water W preferably comprises a water flow directed outwardly from the nozzle around substantially the entire circumference of the nozzle 30 and in a direction substantially perpendicular to a longitudinal axis 42 of the nozzle 30 and/or main body 28. However, it is to be understood that alternative embodiments may employ one or more water flows having varying characteristics.

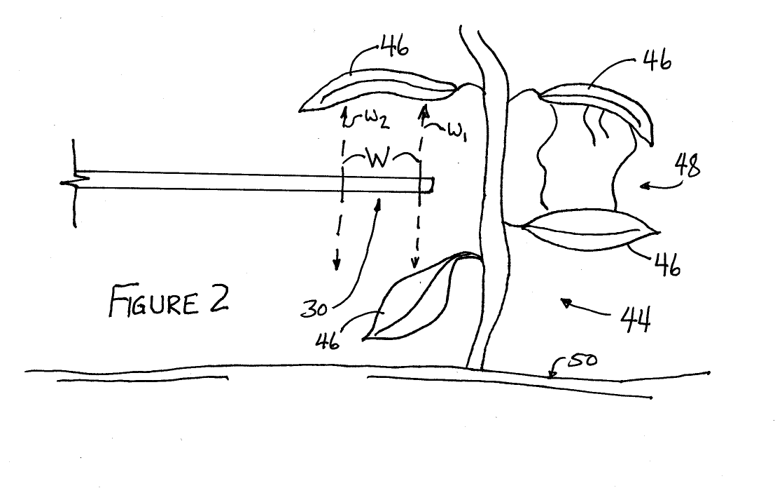

FIG. 2 shows the apparatus 20 of FIG. 1 being used to treat a plant 44 with leaves 46 that have been infested by insects and which have insect waste products 46, such as honeydew, sooty mold, etc. In a preferred method of use, the apparatus 20 is held by the user so that the main body 28 is in a substantially horizontal attitude. In this position, the walls of water W₁, W₂ are directed generally perpendicular to the ground 50. The device 20 is then maneuvered horizontally into and out of the plant 44 so that the walls of water are drawn across the entire length of adjacent leaves 46 in the plant. Additionally, insect waste products 48, such as honeydew and sooty mold, are sprayed by the walls of water W₁, W₂.

As can be seen in FIG. 2, portions of the walls of water W₁, W₂ are directed upwardly to spray the underside of the leaves 46. This spray dislodges insects that may be upon the leaves when the apparatus 20 is moved into the plant. Since each wall of water W extends in substantially all directions within its vertical plane, not only are leaves directly above the apparatus treated, but leaves around the apparatus are also at least partially treated. Additionally, matter 48 between the leaves, such as honeydew and sooty mold, is impacted by at least a portion of each the wall of water W and dislodged from the plants 44.

Flying insects may attempt to evade treatment by avoiding the device's spray pattern and then alighting again on the plant. However, the wall-like water walls W prevent flying insects from bypassing the spray. As such, flying insects are also caught up in the flow.

As the apparatus 20 is drawn out of the plant, each wall of water W₁, W₂ makes another pass by the leaves 46. This second pass provides further treatment, thus, more thoroughly dislodging insects and cleaning the plant. Additionally, insects that may have been dislodged but not completely removed by the first pass of the nozzle will be caught up in the downwardly directed portion of the wall of water. This substantial flow of water tends to carry the insects and waste products downwardly and out of the plant 44. Thus, not only are the insects initially dislodged from the leaves 46 of the plant 44, but the waste products 48 and insects are caught up in the substantial downward flow. Dislodged insects will find it more difficult to realight on the plant, and the cleaning job is more thorough.

Preferably, plant treatment includes advancing and retracting the nozzle 30 in a number of different areas of any single plant 44. Thus, the leaves 46 of the plant 46 are sprayed more than once from a variety of spray angles.

The wall-like flow of water W is also advantageous for efficiency and ease of use. Since water flow is directed outwardly around the circumference of the nozzle 30, it is unnecessary for the user to carefully aim the device to spray specific leaves. Also, the wall flow treats all portions of the leaves, not just the bottoms. In this manner, both the underside and tops of the leaves are cleaned, as well as the space between the leaves.

Since the walls of water W each lie in a substantially vertical plane during use, it is unlikely that the user will be sprayed by the device. Also, the substantially vertical orientation of the walls of water provide more uniform spray of the leaves. As leaves 46 are usually disposed in somewhat of a haphazard pattern within plants 44, the substantially vertical wall of water W will tend to lift leaves above the nozzle 30 so that their undersides may be sprayed effectively.

It is to be understood that an angled spray that is directed generally outwardly around the circumference of the nozzle can also create many of the advantages of the present invention. Though it may not generate a planar spray, a device having such an angled spray pattern would still be able to create a wall of water capable of cleaning the top and bottom sides of leaves, and areas between leaves, without cumbersome aiming. Preferably, such devices produce a spray pattern directed at an angle within about 25° from a plane perpendicular to the nozzle, and more preferably within about 15°. It is also to be understood that such an angled water wall may be combined with a substantially planar water wall.

Although FIG. 2 depicts an apparatus having two spaced-apart parallel walls of water W₁, W₂, it is to be understood that the advantages described above are characteristic of and may also be obtained using only a single wall of water W. However, multiple, spaced-apart water walls can work together on certain leaves to enhance the spraying effect beyond simply another spray pass. For instance, when a leaf is impacted by pressurized water, the leaf tends to bend back dramatically and then rebound toward its former position. During this bend and rebound sequence, certain portions of the leaf may be sprayed ineffectively or missed altogether. In a multiple water wall device, the first wall W₁ first bends a leaf back as the wall passes. Typically, the leaf will at least partially rebound after its initial bend. The second wall W₂ can then come into contact with the partially-rebounded leaf before the first wall has completely passed. Thus, the leaf is in a somewhat different position when the second water wall initiates contact than it was when the first water wall initiated contact. Impacting the leaf from different angles aids in more thoroughly treating the leaf. The combined effect of two or more spaced-apart water walls working together is thus more thorough than the effect of two water walls working independently.

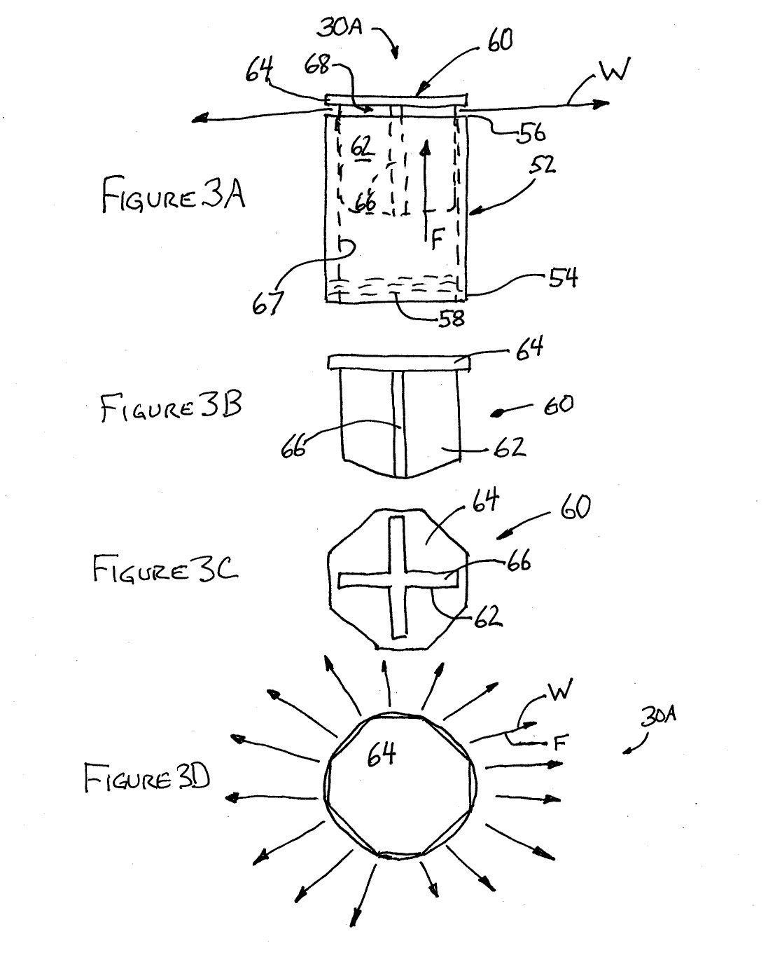

With reference next to FIGS. 3A-D, an embodiment of a nozzle 30A for use in accordance with the present invention is disclosed. The nozzle 30A includes a substantially tubular nozzle body 52 with a proximal end 54 and distal end 56. The proximal end 54 is preferably threaded with a hose or pipe thread 58 and/or includes a connector adapted to establish a watertight connection with main body 28 and handle 26. An end plug 60 is inserted into the distal end 56 of the nozzle body 52. The end plug 60 preferably has an elongate plug body 62 terminating in a distal plate or disk 64. The plug body 62 preferably has a series of ribs 66 extending therefrom, as shown in FIG. 3C. The plate 64 may be circular, hexagonal or any known shape, but is preferably adapted to be able to direct flowing water F outwardly in a substantially evenly-distributed 360° pattern. The plug body 62 is inserted into the distal end 56 of the nozzle body 52 so that the ribs 66 engage an inner wall 67 of the nozzle body 52 and hold the plug 62 in place. A space 68 is defined between the distal end 56 of the nozzle body 52 and the plate 64. The ribs 66 and nozzle body 52 may be threaded to enable the plug body 62 to fit therein, or the plug may be secured using adhesive or any other acceptable means. The space 68 and the plate 64 are adapted so that water flowing F through the nozzle body 52, past the ribs 66, and into contact with the plate 64 is directed outwardly through the space 68 around the entire circumference of the nozzle 30A and substantially perpendicular to the nozzle, forming a wall of water W as shown in FIGS. 3A and 3D.

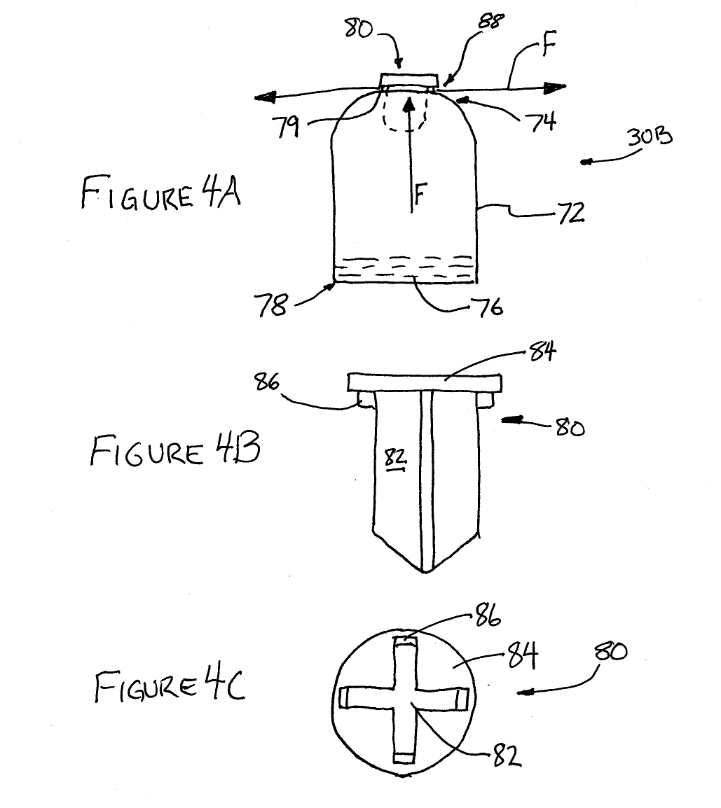

FIGS. 4A-C illustrate another embodiment of a nozzle 30B for use in accordance with the present invention. In this embodiment, a converging nozzle body 72 converges at or near a distal end 74 thereof. A hose or pipe thread 76 or threaded connector on a proximal end 78 of the nozzle body 72 is adapted to be connectable to the handle 26 or main body 28. A distal hole 79 is formed through the distal end 74 and a plug 80 is inserted therethrough. As shown in FIGS. 4B and C, the plug 80 includes an elongate ribbed plug body 82 having a distal plate 84. Spacers 86 extend from the plate. The plug 80 is preferably inserted through the distal hole 79 so that the spacers 86 contact the nozzle body 72 distal end 74 and define a space 88 between the plate 84 and body 72 around a circumference of the nozzle body 72. Pressurized water within the nozzle flows into contact with the plate 84, which directs the flow F outwardly through the space 88 around the circumference of the nozzle 30C in a direction substantially perpendicular to a longitudinal axis of the nozzle.

The converging nozzle body 72 is especially advantageous for use on the distal end of the device. The slanted, converging shape tends to deflect branches when the nozzle is advanced into a plant. Thus, treatment of dense plants, such as hedges, is facilitated.

Although the above-described embodiments include a ribbed plug inserted through a distal hole of the nozzle, it is to be understood that other means may be used to accomplish the desired effect of a spray directed outwardly around the circumference of the nozzle and preferably substantially perpendicular to the nozzle. For example, a circumferential, substantially perpendicular flow of water can be formed by securing a plate 84 having spacers 86 but no elongate body over the distal hole 79 of the nozzle body 72 of FIG. 4A.

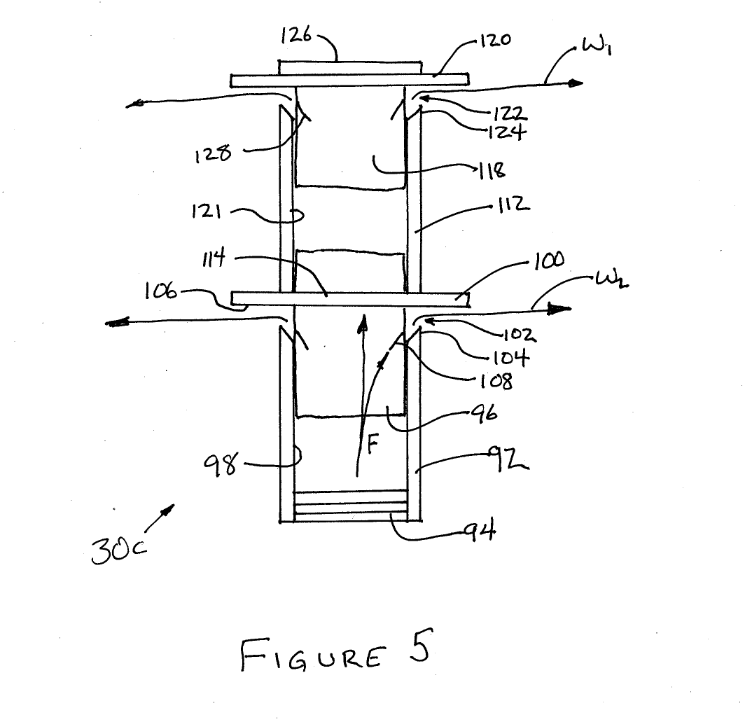

FIG. 5 shows yet another embodiment of a nozzle 30C adapted for use in accordance with the present invention. The nozzle 30C is adapted to create two spaced-apart and outwardly-directed sprays W₁, W₂ that each form substantially contiguous and substantially planar walls of water around the circumference of the nozzle 30C and substantially perpendicular to the nozzle. The nozzle 30C comprises a first outer tube member 92 having a hose or pipe threaded proximal end 94 so as to be attachable to a typical garden hose and/or a main body 28 of the apparatus. An elongate inner tube 96 is secured to the inner wall 98 of the first outer tube 92 and includes a plate or ring 100 extending therefrom. The inner tube 96 is positioned relative to the first outer tube 92 so that a space 102 is provided between a distal end 104 of the first outer tube 92 and a proximal side 106 of the plate 100. At least one perforation 108 is formed through the wall of the inner tube 92 adjacent the space 102 so that at least a portion of the water flow F through the inner tube 92 is directed outwardly through the space 102 and is directed by the plate 100 to create a wall of water W₂ around the circumference of the nozzle 30C and in a plane substantially perpendicular to the nozzle. Most preferably, a plurality of perforations 108 are provided so that flow F through the space 102 is substantially uniform around the circumference of the nozzle 30C.

A second outer tube 112 is attached to a distal side 114 of the first plate 100 and/or to a distal end 116 of the first inner tube 92. A second inner tube 118 having a second plate 120 is secured to the inner wall 121 of the second outer tube 112 so that a space 122 is provided between the distal end 124 of the second outer tube 112 and the plate 120. The second inner tube 118 has a plug 126 on its distal end. At least one perforation 128 is formed through the second inner tube 118 so that water flow F through the tube 118 is directed outwardly through the space 122 to create a wall of water W₁ around the circumference of the nozzle 30C in a manner as described above for the first outer tube 92 and first inner tube 96. Preferably, the first and second plates 100, 120 are spaced apart from each other a distance of between about 1″ to 6″.

It is to be understood that, if desired, a nozzle can be constructed after the manner described above to be capable of creating more than two planar walls of water W. Such a nozzle may be constructed by adding, in series, portions similar to the first inner tube 92 and outer tube 96. Any number of planar walls of water may be created, as desired. However, available water pressure may limit the number of walls that can be effectively created. Use of one or two water walls is most preferred.

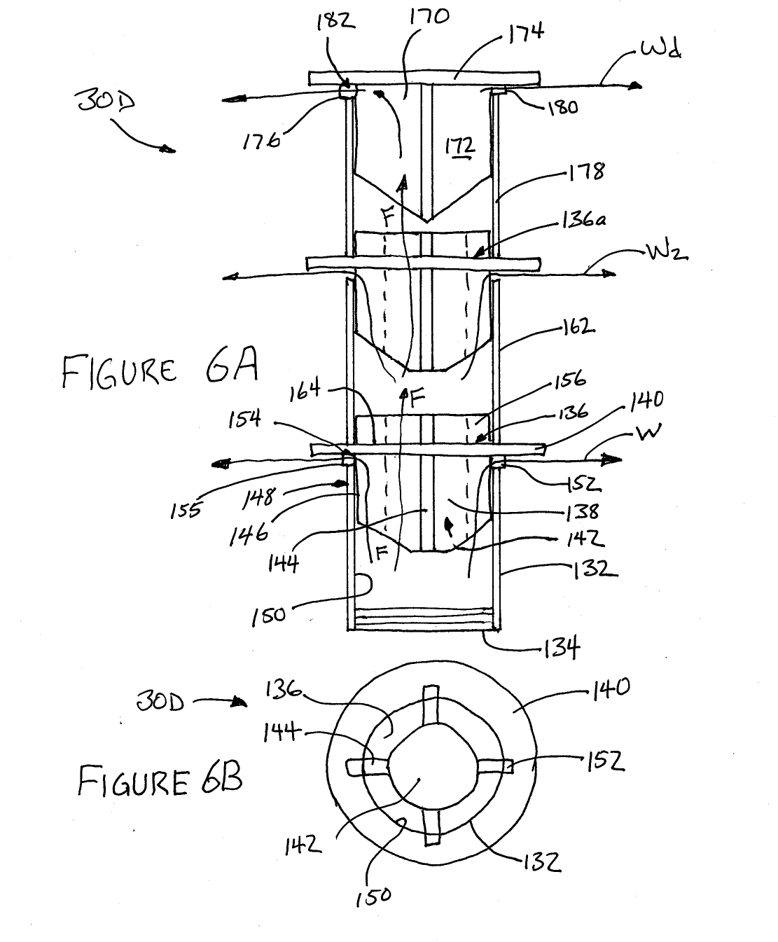

FIGS. 6A and B illustrate a still further embodiment of a nozzle 30D adapted for use in accordance with the present invention. The nozzle 30D includes a first tube 132 having a hose or pipe threaded proximal connector 134 adapted to accommodate a garden hose or other threaded connector. It is to be understood that other water-tight connectors may appropriately be used, such as bayonet-type connectors. An intermediate plug 136 comprises an elongate body 138 connected to a plate or disk 140. A passage 142 is formed longitudinally through the body 138, and longitudinal ribs 144 extend from the body 138. A proximal portion 146 of the intermediate plug is secured within a distal portion 148 of the first tube 132 so that the ribs 144 engage and are secured to an inner wall 150 of the tube 132. Preferably, spacers 152 extend from the plate 140 so that a desired space 154 is defined around the circumference of the nozzle 30D between a distal end 155 of the first tube 132 and the plate 140. A distal portion 156 of the intermediate tube 136 extends distally from the plate 140. When a water flow F is directed through the nozzle 30D, a portion of the water flows between the ribs 144 and the inner wall 150 of the first tube and into contact with the plate 140. The plate directs the water through the space 154, forming a substantially planar wall of water W spraying outwardly around the circumference of the nozzle. Water flow F not directed through the space flows through the plug passage 142 and into a second tube 162.

The second elongate tube 162 is secured to a distal side 164 of the plate 140 and/or the distal portion 156 of the intermediate plug 136. Another intermediate plug 136a is positioned through a distal end of the second tube 162 in the same manner as with the first tube 132 so that a second planar wall of water W₂ is created spraying outwardly around the circumference of the nozzle. Subsequent tube/intermediate plug arrangements can be added to create as many planar walls of water as may be desired. An end plug 170 having an elongate ribbed body 172 terminating at a plate 174 is positioned through a distal end 176 of a distal-most tube 178 of the nozzle 30D. The end plug plate 174 has spacers so that a desired space 182 is defined between the distal end 176 of the distal tube 178 and the plate 174. The water flow F remaining in the nozzle is directed through this circumferential space 182 to create a distal water wall W_{d}.

Each of the nozzle embodiments described above preferably has an outer diameter of between about ¼″ to 1″ and more preferably between about 1½″ to ¾″, and is preferably adapted to be connectable to pipes and hoses of standard sizes. This allows the nozzle to be used with a wide range of water supply and handle apparatus. Any suitable material or combination of materials may be used to construct the nozzles. For instance, the nozzles can be constructed of materials such as brass and/or plastics such as polyvinylchloride (PVC) and acrylonitrile-butadiene-styrene (ABS).

As discussed above, the embodiments of nozzles adapted to form multiple walls of water can be adapted to have as many walls as the user desires, and these walls can be any desired distance, but are most preferably between about 1″ to 6″ apart. In an alternative embodiment, the tube components may be provided in various lengths so that the user can quickly rearrange the tube sizes to change the distance between water walls. In one such embodiment, the intermediate plug ribs are threaded to match corresponding threads on the inner walls of the tubes. In this manner, the plugs can be selectively and releasably mated with a tube having a desired length, thus allowing the user to easily choose the distance between water walls in order to customize the device for a particular plant or leaf size.

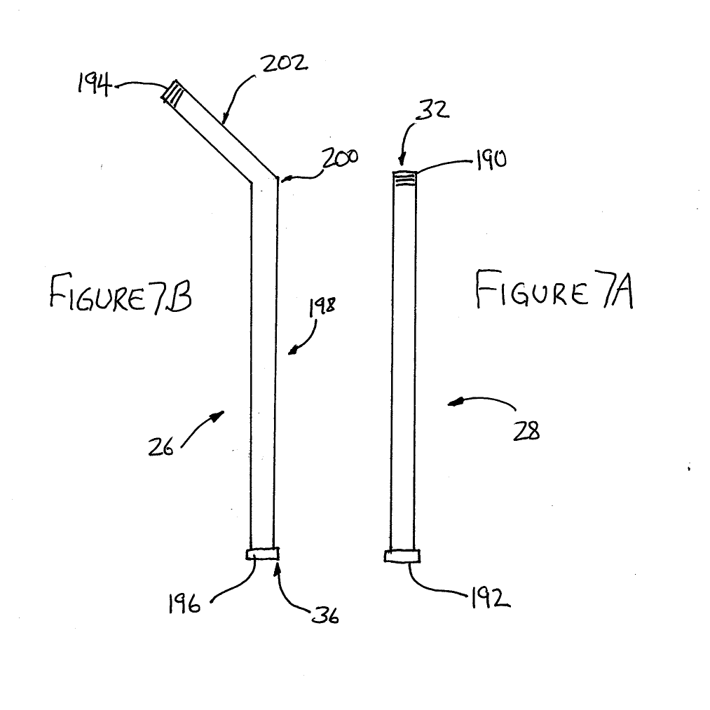

As discussed above with reference to FIG. 1, the apparatus 20 preferably includes a tubular main body 28 and tubular handle portion 26. FIGS. 7A and B illustrate side views of these portions unattached to each other. It is to be understood that the main body 28 and handle 26 sections can be formed as one piece or in a plurality of connectable modules of various lengths.

With reference first to FIG. 7A, the main body 28 preferably comprises a substantially straight, tubular pipe having male hose or pipe threads 190 on the distal end 32 and a female proximal connector 192. The main body 28 preferably has a length of between about 1-6 ft. and more preferably is between about 18″ to 60″ long. The pipe preferably is of a standard size, having a diameter between about ¼″ to 1″ and more preferably between about 1½″ to ¾″.

With reference next to FIG. 7B, the handle portion 26 also preferably comprises substantially rigid pipe having a threaded distal male connector 194 and a proximal female connector 196. A first straight portion 198 preferably extends from the proximal connector 196 to a bend point 200. A second straight portion 202 preferably extends from the bend point 200 to the distal connector 194. The first portion 198 of the handle is preferably between about 1-6 ft. long and more preferably is between 18″ to 60″ long. The second portion 202 of the handle is preferably between about 2″ and 2 ft. long, and more preferably is between about 4″ to 14″ in length. The handle is bent at the bend point 200 at any angle between 0° and 90°, but is most preferably bent at an angle between about 30° to 60°. With reference also to FIG. 1, the handle 26 preferably is connected at the proximal connector 196 to the controller 34, which communicates with a garden hose 38 or another source of water under pressure. The distal end 194 of the handle is preferably connected to the main body 28, which is in turn connected to the nozzle 30. Alternatively, the nozzle may be connected to the handle and the main body not used.

It is to be understood that although the handle portion 26 and main body portion 28 are preferably tubular and adapted to communicate pressurized water therethrough, alternative embodiments of these portions can comprise hollow or solid structural members that are not adapted to carry water therethrough. In such cases, an external flexible or rigid water delivery tube communicates water from the source of pressurized water to the nozzle.

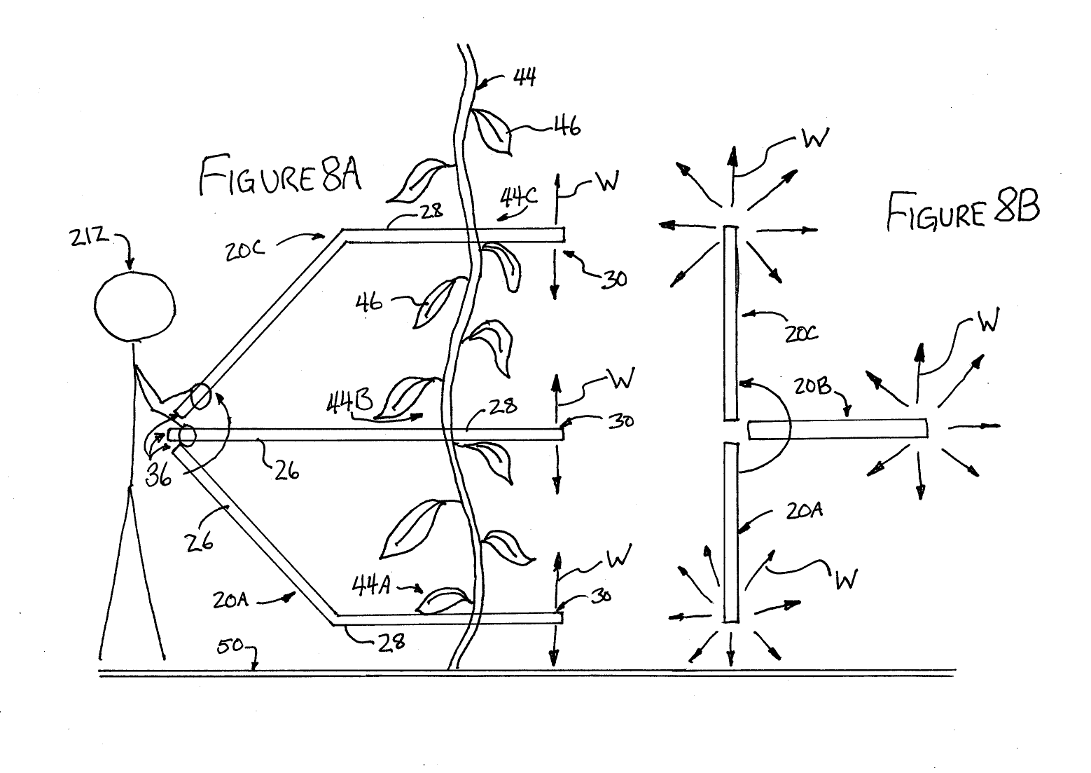

As discussed above, the spraying device is most effectively used with the nozzle 30 and main body 28 in a substantially horizontal orientation. With reference next to FIGS. 8A and B, an assembled device 20A, 20B, 20C is shown being used at three separate elevations within a plant 44: bottom region 44A, middle region 44B and overhead region 44C. As can be seen in the figures, the main body portion 28 can be maintained in a substantially horizontal attitude with the proximal control end 36 of the handle portion, being maintained at substantially the same elevation. For example, to reach the bottom-most regions 44A of a plant, the handle is angled downwardly from its control end 36 so that the main tube 28 is substantially horizontal and adjacent the ground 50. This allows effective treatment of the low portions 44A of the plant without excessive bending over and straining by the user 212. To reach the middle elevations 44B of the plant, the user need only rotate the device about the control end 36. The control end 36 remains at substantially the same elevation while the main body 28 is elevated, but maintained in a horizontal attitude. Because each of the vertical walls of water W are substantially contiguous around the entire circumference of the nozzle 30, the rotation of the tubular main body 28 does not change the effectiveness of the water walls W so long as the main body 28 is maintained substantially horizontal. Thus, rotation of the device does not affect the spray, but allows easy changing of elevation of the spray without dramatic adjustments on the part of the user.

Any suitable materials or combination of materials can be used for the handle and main body portions. Most preferably, the tubes comprise pipe constructed of aluminum or plastic, such as PVC or ABS. Additionally, as discussed above, the handle and main body may be integrally formed or may comprise a multitude of segments. Also, extensions may be added to enable treatment of tall plants such as trees and the like.

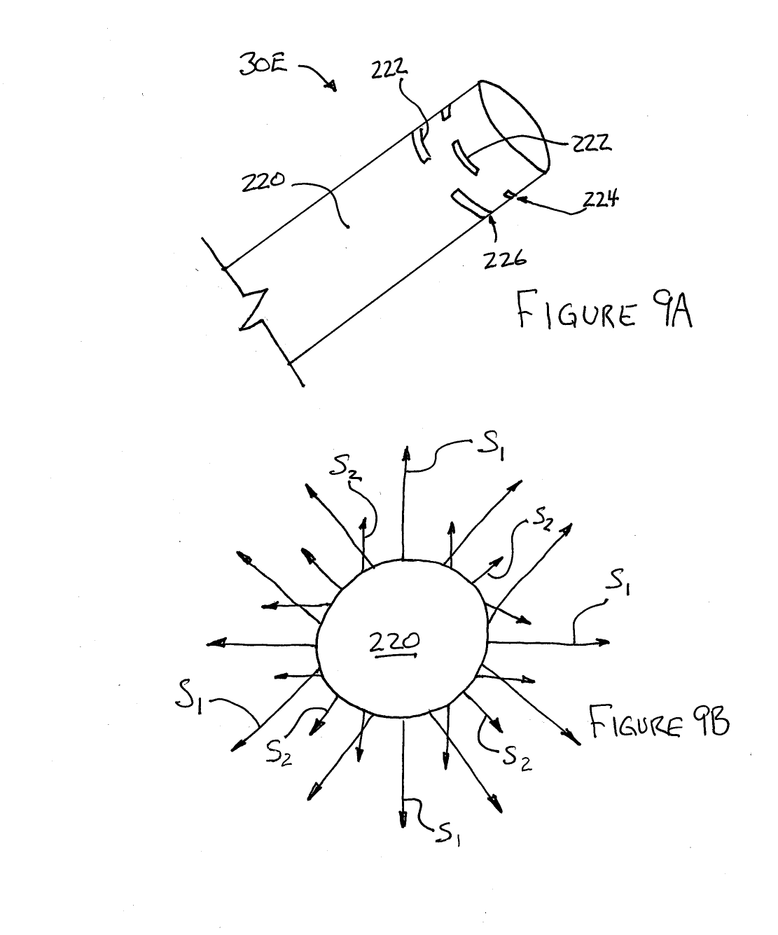

With reference next to FIGS. 9A and B, a yet further embodiment of a nozzle 30E for use in accordance with the present invention comprises a nozzle tube 220 having a plurality of slits 222 formed therethrough. Each slit 222 is adapted to direct a fan spray of water outwardly therefrom. Preferably, the slits 222 produce fans of water that collectively surround the entire circumference of the nozzle 30E; however, the slits do not necessarily create a contiguous sheet of water around the circumference.

In the embodiment shown in FIGS. 9A and 9B, a first set 224 of slits 222 comprises a plurality of slits 222 spaced apart from each other and arranged about the circumference of the nozzle tube 220. A second set 226 also comprises a plurality of slits 222 spaced apart from each other and arranged about the circumference of the nozzle tube 220. The second set 226 is longitudinally spaced a short distance from the first set 224, and the second set slits are arranged to roughly correspond to the spaces between the first set slits. FIG. 9B depicts fan sprays Si of slits in the first set 224 as long arrows and fan sprays S2 of slits in the second set 226 as short arrows. As can be seen from FIG. 9B, the sprays S1, S2 from the first and second sets 224, 226 substantially overlap each other. In this manner, the first and second sets 224, 226 provide thorough coverage of spray around the circumference of the nozzle. It is to be understood, however, that acceptable spray coverage around the circumference of the nozzle 30E can be attained with only the first set 224, especially if the fan sprays overlap each other. In this manner, a non-contiguous series of fan sprays can still function as a water wall due to their overlapping arrangement.

The slits 222 are each preferably adapted to direct the fan sprays S₁, S₂ of water in a plane substantially perpendicular to a longitudinal axis of the nozzle, but it is to be understood that the slits can be adapted to spray water in a variety of directions relative to the nozzle axis. Preferably, the slits are adapted so that the water does not spray back onto the user when the nozzle is substantially horizontally oriented. Most preferably, the slits 222 direct fan sprays S of water lying in substantially vertical planes when the nozzle 30E is held in a horizontal position.

In certain applications, it may be desirable to minimize the downflow of water from the device. It would still be desired, however, to enable convenient treatment of the undersides of leaves at various elevations within the plant. Accordingly, an alternative embodiment of the invention includes a nozzle adapted to direct a spray outwardly around at least a semicircular portion of the nozzle. The device is preferably configured to be easily used at various elevations within a plant in a manner similar to the device 20A, 20B, 20C discussed above with reference to FIG. 8. The nozzle is preferably connected to the handle 26 and main body 28 so that a first side portion of the semicircular flow is directed upwardly when the device is used in the bottom region 44A of the plant, a middle portion of the semicircular flow is directed upwardly when the device is used in the middle region 44B of the plant, and a second side portion of the semicircular flow is directed upwardly when the device is used in the overhead region 44C of the plant.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

1. (canceled)

2. (canceled)

3. (canceled)

4. A hand held spray apparatus for removing insects from and cleaning plant leaves, the apparatus comprising:
a substantially rigid handle portion;
an elongate, substantially rigid body portion communicating with the handle portion; and
a nozzle portion at a generally distal end of the body portion, the nozzle portion adapted to be connected to a source of pressurized water and to direct the pressurized water in a flow directed substantially outwardly from the nozzle portion and around at least half of the circumference of the nozzle portion

5. The apparatus of claim 4, wherein the nozzle portion is adapted to create a substantially uniform wall of pressurized water, the water wall lying in a plane substantially perpendicular to a longitudinal axis of the body portion and completely encircling the body portion.

6. The apparatus of claim 5, wherein the water wall is substantially contiguous about the nozzle portion.

7. (canceled)

8. (canceled)

9. The apparatus of claim 4, wherein at least part of the pressurized water flow is directed outwardly from the nozzle at an acute angle relative to a longitudinal axis of the nozzle.

10. The apparatus of claim 4, wherein the nozzle portion comprises means for creating a substantially uniform wall of pressurized water, the water wall lying in a plane substantially perpendicular to a longitudinal axis of the body portion and completely encircling the body portion.

11. The apparatus of claim 4, wherein the nozzle portion is adapted to create a series of fan sprays of pressurized water directed in a plurality of substantially parallel, substantially vertical planes when the longitudinal axis of the body portion is substantially horizontal, the series of fans of water collectively spraying water outwardly around the circumference of the nozzle portion.

12. The apparatus of claim 4, wherein the nozzle portion comprises a tube and an end plug, the end plug having a plug body and a dispersing plate, at least a portion of the plug body lying within the tube, and a space defined between the dispersing plate and a distal end of the tube so that water flowing through the nozzle portion flows between the tube and the plug body and through the space.

13. (canceled)

14. (canceled)

15. (canceled)

16. The apparatus of claim 4, wherein the body portion is substantially straight and the handle portion comprises a bend point.

17. The apparatus of claim 16, wherein the handle portion and body portion are integrally formed.

18. The apparatus of claim 16, wherein the handle portion and body portion comprise a plurality of modules.

19. A method for removing insects from and cleaning a plant having leaves, the method comprising:
providing a hand held spraying apparatus having a handle, an elongate body portion, and a nozzle portion at a distal end of the body portion, the nozzle portion adapted to direct water flow outwardly therefrom around the circumference of the nozzle portion;
providing a source of water under pressure;
placing the spraying apparatus into communication with the source of water under pressure;
positioning the nozzle adjacent an underside of a plant leaf so that a portion of the water directed by the nozzle impacts the leaf underside; and
advancing and retracting the apparatus so that a flow of water impacts the leaf underside along its length.

20. The method of claim 19, wherein the elongate body portion is substantially straight.

21. The method of claim 20, wherein the nozzle is adapted to direct a flow of water in a substantially vertical plane.

22. The method of claim 20, wherein at least one of the substantially vertical planes is substantially perpendicular to the nozzle portion and comprising the step of holding the elongate body in a substantially horizontal attitude.

23. The method of claim 22, wherein the handle includes a bend point and comprising step of adjusting the elevation of the body portion by rotating the handle about a proximal end of the handle.

24. The method of claim 19, additionally comprising advancing and retracting the apparatus into and out of the plant at a plurality of locations so that water directed by the nozzle simultaneously impacts the top side of a first plant leaf along at least a portion of its length and the underside of a second plant leaf along at least a portion of its length.

25. The method of claim 19, wherein the nozzle is adapted to create a substantially planar and contiguous wall of water around the circumference of the nozzle.

26. The method of claim 25, wherein the nozzle is adapted to create two or more substantially planar and contiguous walls of water around the circumference of the nozzle, the walls of water being spaced apart from each other.

27. The method of claim 25, additionally comprising advancing and retracting the nozzle between leaves of the plant so that the portions of the wall of water simultaneously impact undersides of leaves generally above the nozzle, top sides of leaves generally below the nozzle, and any matter that may be between the leaves of the plant.

28. The method of claim 27, additionally comprising advancing and retracting the nozzle between leaves of the plant at a plurality of locations.
